(19) United States
(12) Patent Application Publication
(10) Pub. No.: US 2023/0278240 A1
(43) Pub. Date: Sep. 7, 2023

(54) UTILITY KNIFE

(71) Applicants: Norbert FROHNE-BRINKMANN, Wuppertal (DE); Martin ROHRBACH, Horn (DE)

(72) Inventors: Norbert FROHNE-BRINKMANN, Wuppertal (DE); Martin ROHRBACH, Horn (DE)

(21) Appl. No.: 18/197,341

(22) Filed: May 15, 2023

Related U.S. Application Data
(63) Continuation-in-part of application No. 15/793,375, filed on Oct. 25, 2017, now abandoned.

(30) Foreign Application Priority Data
Oct. 31, 2016 (DE) 102016012990.5

(51) Int. Cl. B26B 5/00

(52) U.S. Cl. CPC B26B 5/00; B25G 1/08

(57) ABSTRACT

A knife having an elongated housing having a channel-shaped laterally open recess and forming first and second housing surfaces, a blade, a support having a support outer surface and pivotal about an axis on the housing between an operating position and a blade-replacement position, and a cover having a cover outer surface and movable on the support between a position holding the blade against the support and a position free of the blade, the first and second housing surfaces tapering relative to each other in a clamping region or the outer surfaces tapering relative to each other in the clamping region. In the operating position the support is inside the housing and holds the blade inside the housing with only a part of a cutting edge of the blade exposed in the recess for engagement with material to be cut.

### CROSS REFERENCE TO RELATED APPLICATION

This application is a continuation-in-part of copending application Ser. No. 15/793,375 filed 25 Oct. 2017 with a claim to the priority of German patent application 20 2016 012 990.5 filed 31 Oct. 2016.

### FIELD OF THE INVENTION

A knife of this type is known from obvious prior use. The knife is usually used for cutting strapping, films or material webs. A blade is securely arranged in a housing of the knife. The cutting edge of the blade is only accessible via a channel-like recess of the housing. In this manner, it is not possible for a user to come into contact with the blade, because the recess is dimensioned in such a manner that body parts, such as for example fingers, cannot be moved through the recess as far as the cutting edge. The knife is provided with a hook-shaped projection, in order to engage behind the cutting material and guide the cutting material to the cutting edge. The blade can be changed in that, after loosening a screw, a flap-like housing region is pivoted into an open position.

### OBJECT OF THE INVENTION

The object of the invention is to improve the knife in such a manner that the blade support and the blade are held without play in the housing of the knife. In particular, it should not be possible for cutting material to settle between the blade and blade holder. Nonetheless, a blade change should be possible without great effort.

### SUMMARY OF THE INVENTION

The knife comprises a housing and a blade support with a blade cover, wherein a blade is held in a detachable manner between the blade support and the blade cover. The blade support is movable between an operating position and a blade replacement position. In the blade replacement position, the blade support is moved so far out of the housing that the blade cover can be removed from the blade support the blade can be replaced, in the operating position, the blade support is arranged in the housing in such a manner that a cutting process can be carried out. The blade support comprises a first outer surface and the blade cover comprises a second outer surface. In the operating position, the first outer surface interacts with a first housing surface and the second outer surface interacts with a second housing surface in such a manner that the blade is clamped between the blade support and the blade cover.

In this manner, the blade is securely clamped between the blade support and the blade cover. Cutting material cannot settle between the blade and the blade support or between the blade and the blade cover and lead to contamination of the knife. According to one embodiment, the blade support moves between the blade replacement position and the operating position within a plane.

For example, at least one of the outer surfaces, i.e. the first outer surface and/or the second outer surface, is inclined toward the plane. The outer surface is inclined with respect to the plane in such a manner that during the movement of the blade support from the blade replacement position into the operating position, a clamping force acts on the outer surface that clamps the blade between the blade support and blade cover. Alternatively or additionally, for example at least one housing surface, i.e. the first housing surface and/or the second housing surface is inclined with respect to the plane. Also, in this case, the inclination of the housing surface is such that during the movement of the blade support from the blade replacement position into the operating position, a clamping force acts on the outer surface that clamps the blade between the blade support and the blade cover.

The outer surface or the housing surface is formed for example by a punctiform holding face. That is to say, the surface is so small that it is of punctiform construction. At least one outer surface or at least one housing surface can be constructed for example with a projection or more projections to increase the clamping of definite areas of the blade support. The outer surface and the housing surface cooperate in this case to increase the clamping effect. The projection can for example surround the channel-like recess to intense clamping of this area. If the projection is on the outer surface it is directed to the housing surface and if the projection is provided on the housing surface it is directed to the outer surface.

For example, two housing surfaces and/or two outer surfaces are arranged conically. The surface pair that forms the conical arrangement is constructed such that the blade is clamped between the blade cover and the blade support, whilst the blade support moves between the blade replacement position and the operating position.

The housing surface and/or the outer surface are for example arranged conically in such a manner that during the movement from the blade replacement position into the operating position, the clamping forces acting on the outer surfaces increase. In other words, the clamping forces increase the further the blade support is moved in the direction of the operating position.

The blade support forms a pivot joint for example with the housing, so that the blade support can be pivoted between the operating position and the blade replacement position. According to an alternative, the blade support could execute for example a straight-line movement or a mixed movement with rotational and straight-line portions during the movement between the operating position and the blade replacement position.

The blade is in the operating position in the housing in such a manner that a region of a cutting edge of the blade is exposed in a channel-like recess, so that cutting material can be supplied to the cutting edge via the channel. The cutting edge delimits the recess in the operating position of the blade support. The cutting edge faces for example an opening of the recess. The recess is dimensioned for example in such a manner that body parts of the user can no longer come into contact with the cutting edge.

The blade support can be arrested in the operating position and/or in the blade replacement position for example by a locking device, having first locking means that are engaged in a detachable manner with second locking means of the housing. The locking means are formed for example by interacting positive-fitting means. The locking device can be constructed for example as a latching device.

The first locking means are for example arranged at an end region of the blade support facing away from the pivot joint. Owing to the lever arm between the pivot joint and the locking device, the blade support is held securely in the locked position in spite of the relatively low forces which act on the locking device.

The blade support comprises for example a control, at which it can be pivoted by a user between the operating position and the blade replacement position, wherein the control is at an end region facing away from the pivot joint. The large lever arm allows a movement of the blade support into the operating position without great effort, even if the blade support and the blade cover are clamped in the housing.

The blade support comprises for example a blade seat in which the blade is held. The blade seat comprises for example a holding face of the blade support or two opposite holding faces of the blade support and the blade cover, between which the blade is held. For example, the blade seat comprises positive-fitting means, using which the blade is held in a certain position relative to the blade support.

For easier removal of the blade from the blade seat, the blade support comprises for example a recess, into which a region of the blade protrudes. This makes it possible to grip behind the blade, so that it can be detached from the blade seat more easily.

### BRIEF DESCRIPTION OF THE DRAWING

Further advantages emerge on the basis of an embodiment illustrated in the drawing in which:

FIG. 1 is a perspective view of the knife, wherein a blade support is in the operating position,

FIG. 2 is a perspective view of the knife, wherein the blade support is in a blade replacement position, and wherein a blade cover is located in a closed position,

FIG. 3 is a perspective view of the knife, wherein the blade support is in a blade replacement position, and wherein the blade support is located in an open position,

FIG. 4 is a side view of the housing,

FIG. 5 is a view of the housing according to view arrow V in FIG. 4,

FIG. 6 is a section in accordance with a section line VI-VI in FIG. 5,

FIG. 7 is a side view of a first side of the blade support,

FIG. 8 is a side view of a second side of the blade support opposite the first side,

FIG. 9 is a partial view of the blade

FIG. 10 is a partial view of the blade cover

FIG. 11 is an exploded illustration of blade support, blade and blade cover,

FIG. 12 is a side view of the blade support including a blade and replacement blade each mounted in a blade seat,

FIG. 13 is a side view of the knife, wherein the blade support is located in the operating position,

FIG. 14 is a view according to view arrow XIV in FIG. 13,

FIG. 15 is a sectional illustration in accordance with a section line XV-XV in FIG. XIV,

FIG. 16 is a side view of the knife, wherein the blade support is in the blade replacement position and the blade cover is located in the open position,

FIG. 17 is a section in accordance with section line XVII-XVII in FIG. 13,

FIG. 18 is a detail view according to section line XVIII in FIG. 17,

FIG. 19 is a section in accordance with section line XIX-XIX in FIG. 4,

FIG. 20 is a perspective illustration of the housing sectioned according to the section XIX-XIX,

FIG. 21 is an enlarged detail view according to section line XXI in FIG. 20,

FIG. 22 is a side view of the knife, wherein the blade support is between the blade replacement position and the operating position.

The knife as a whole is labeled in the figures with the reference number 10. Identical reference numbers in the different figures designate corresponding parts, even if lower case letters have been added or omitted.

### SPECIFIC DESCRIPTION OF THE INVENTION

The knife 10 comprises a housing 11, on which a handle region 12 is constructed. The knife 10 can be held on the handle region 12. A channel-like recess 13 is provided on the housing 11, which has opposite guide surfaces 14 and 15. Cutting material can be guided through the recess 13 to the cutting edge 16 of a blade 17. The cutting edge 16 delimits the recess 13 and faces in the direction of the recess 13. The guide surface 15 is constructed on a hook-shaped protrusion 18 of the housing 11. Discharge surfaces 19 are constructed on opposite sides of the housing 11, in order to convey the cut material away from the blade 17. The housing 11 is provided with a through hole 21 at a rear end region 20, which through hole can be used for example for suspending the knife 10. In order to prevent slipping of the fingers, the housing 11 is provided with structures 24 on two opposite sides 22a and 22b and on a knife rear 23.

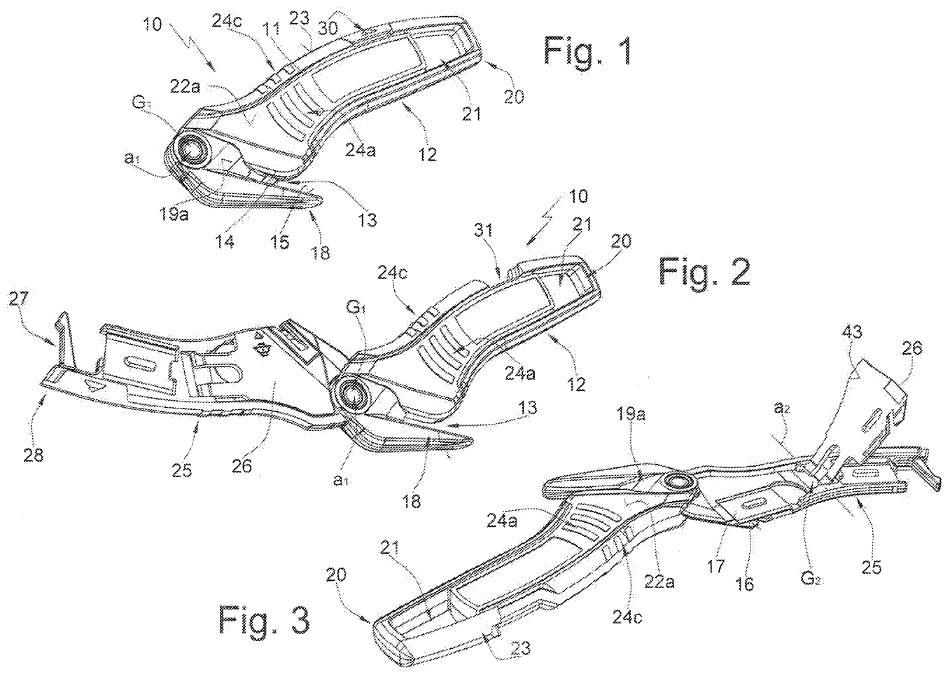

A blade support 25 can be seen in FIG. 2, on which the blade 17 is held. The blade support 25 is mounted on the housing 11 such that it can be pivoted between the blade replacement position illustrated in FIG. 2 and the operating position illustrated in FIG. 1. A pivot joint G1 with a pivot axis a₁ is formed between the blade support 25 and the housing 11. From the operating position, the blade support 25 can be pivoted relative to the housing 11 about the pivot axis a₁ in direction u1 into the blade replacement position. From the blade replacement position, the blade support 25 can be pivoted about the pivot axis a₁ in the direction u2 into the operating position.

The blade 17 is held between the blade support 25 and a blade cover 26 according to FIG. 2. The blade cover 26 can be pivoted between the closed position shown in FIG. 2 and an open position illustrated in FIG. 3. In the open position, the blade 17 can be removed from the blade support 25 and replaced by a new blade 17. The blade cover 26 forms a pivot joint G2 with a pivot axis a₂ with the blade support 25.

Furthermore, an arm 27 can be seen in FIGS. 2 and 3 that is located on an end region 28 of the blade support 25 facing away from the pivot axis a₁. The arm 27 is part of a locking device. The arm 27 is provided with first locking means that interact with second locking means of the housing 11. In the present embodiment, the arm has a hook-shaped end. In FIG. 2, an actuating region 30 at the end region 28 can move the blade support 25 between the operating position and the blade replacement position. In the operating position, the blade support 25 is completely inside the housing 11, so that the blade support 25 can only be actuated from outside at the actuating region 30.

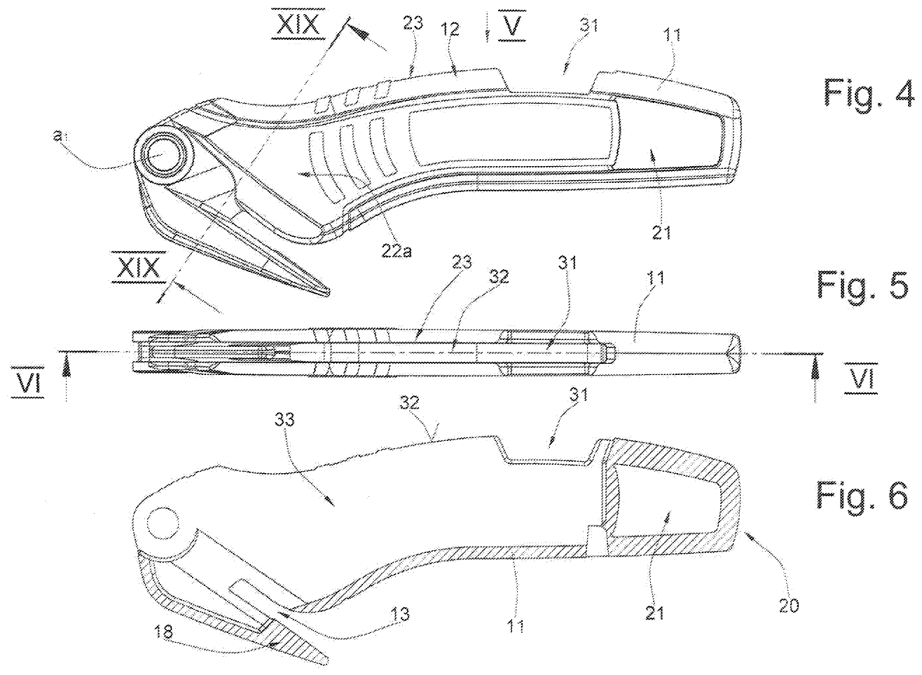

A side view of the housing 11 is shown as an individual component in FIG. 4. A recess 31 for the actuating region 30 can be seen on the housing 11. The recess 31 extends over the knife rear 23 on both sides 22a and 22b of the housing 11. The knife rear 23 is provided with a slotted opening 32 that is connected to an interior 33 of the housing 11 that can be seen in FIG. 6 in particular. Through the opening 32, the blade support 25 can be pivoted into the interior 33 into the operating position and out of the interior 33 into the blade replacement position.

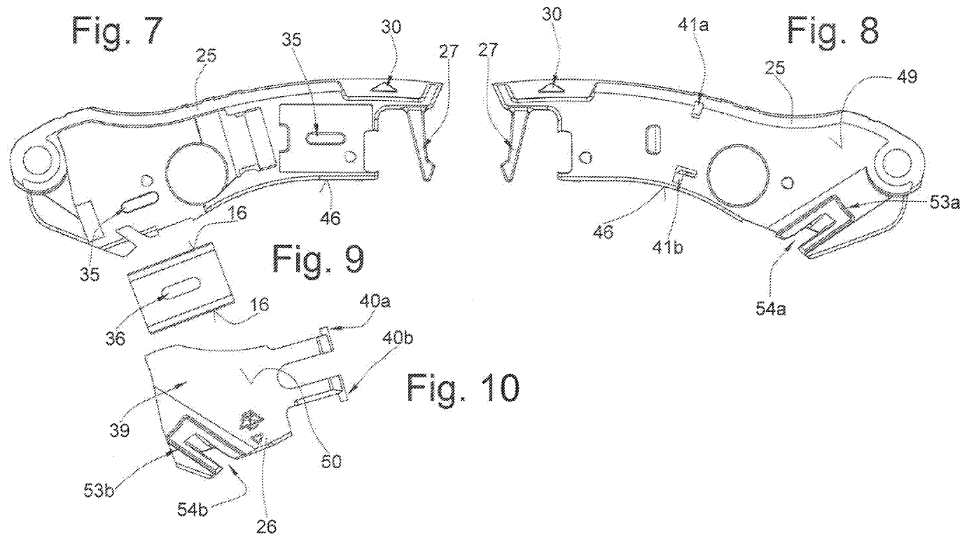

Both sides of the blade support 25 are illustrated in FIGS. 7 and 8. According to FIG. 7, a first blade seat 34 for the blade 17 provided for cutting is constructed on the blade support 25. A web-shaped projection 35 is constructed on the blade seat 34 that engages through a complementary recess 36 in the blade 17 when the blade 17 is located in the first blade position 34. When the blade 17 is in the first blade seat 34, it overlaps with an opening 37. This opening 37 facilitates the removal of the blade 17 from the first blade seat 34, because it is possible to grip behind the blade 17 in this manner (see for example FIG. 12).

An outer surface 49 of the blade support 25 as illustrated in FIG. 8 has a projection 53a that surrounds a recess 54a in the blade support 25. Recess 54a inter alia forms the channel-like recess 13. The projection 53a in this embodiment has the form of a line but as an alternative it could also have the form of a broken line or as a further alternative the outer surface could be formed with one or more punctual projections. These variants of the projection could also be formed on the housing surface 48a as an alternative.

As can be seen in FIG. 10 an outer surface 50 of the blade cover 26 has a projection 53b that surrounds a recess 54b in the blade cover 26 which also forms inter alia the channel-like recess 13. The projection 53b can as an alternative have the same variants as the projection 53a and could also alternatively be on the housing surface 48b.

The projections 53a and 53b have the function to increase the clamping force together with the housing surfaces 48a and 48b in the area next to the channel-like recess 13 so that no cutting material can enter between the blade 17 and the blade support 25 or the blade cover 26. Not shown in this embodiment but in addition other areas of the outer surfaces 49 and 50 or housing surfaces 48a and 48b could have projections to increase the clamping forces.

Furthermore, a second blade seat 38 for blades 17 that are provided as replacement parts, is constructed in a rear region of the blade support 25. In FIG. 9, the blade 17 used in the present embodiment is illustrated, which blade has two cutting edges 16. The blade cover 26 is illustrated in FIG. 10. The blade cover has a plate-shaped region 39 and two pins 40a and 40b that form the pivot axis a₂ together with the recesses 41a and 41b of the blade support 2b.

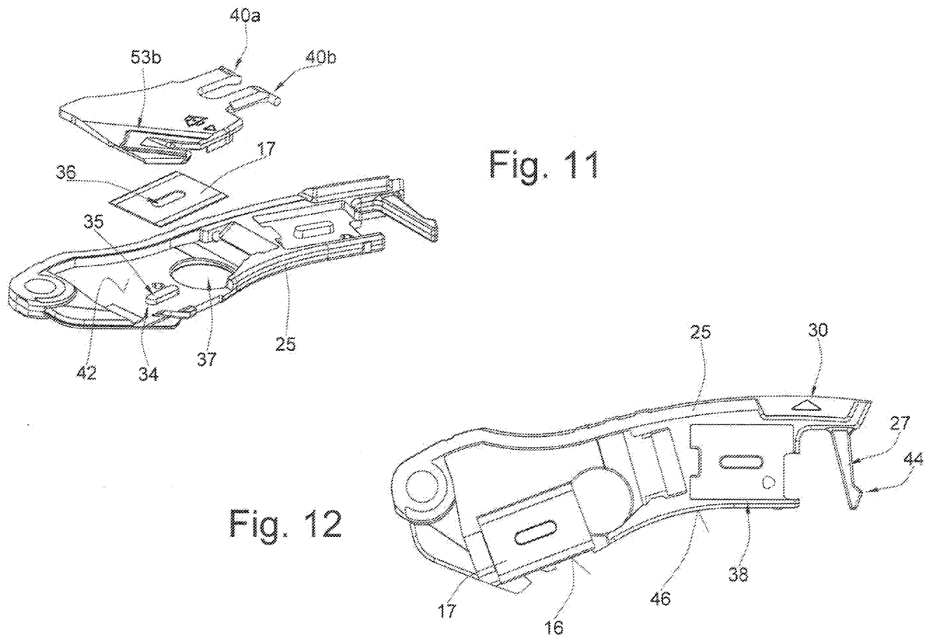

The arrangement of the blade 17 in the first blade seat 34 between a holding face 42 of the blade support 25 and a holding face 43 (see FIG. 3) of the blade cover 26 can be seen in FIGS. 11 and 12.

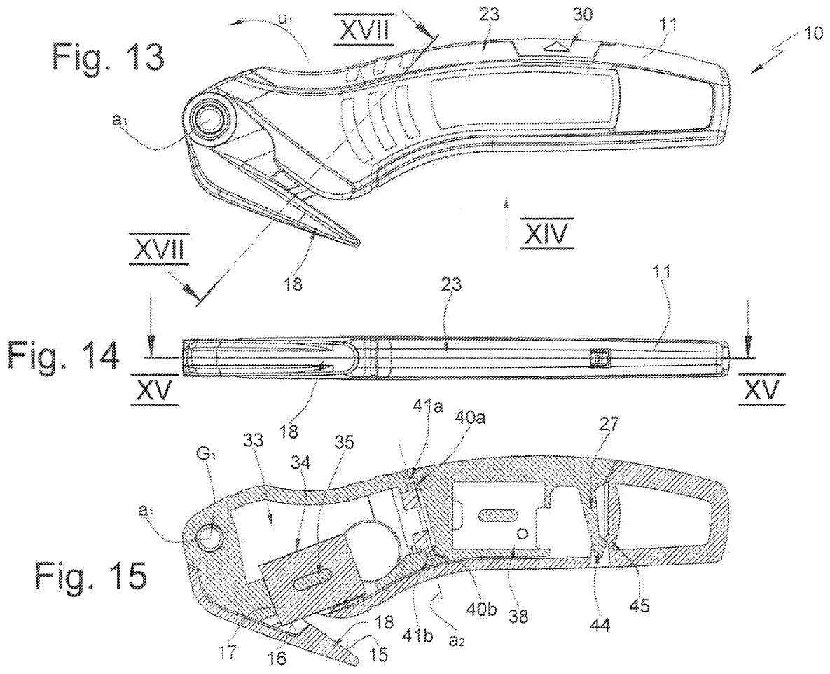

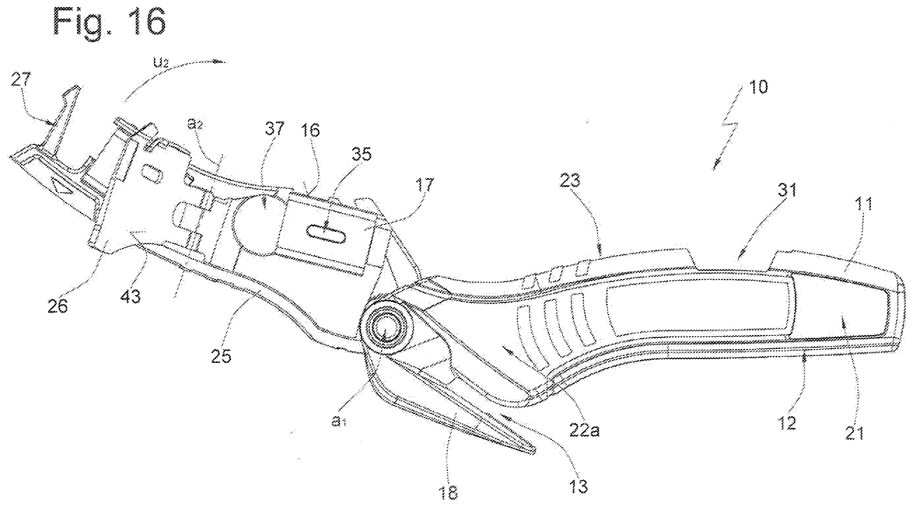

According to FIGS. 13 to 15, the blade support 25 is in the operating position, so that a cutting process can be carried out. The first locking means 44 are in engagement with the second locking means 45 and hold the blade support 25 in the operating position. According to FIG. 15, in the operating position, a stop surface 46 of the blade support 25 bears against a mating surface of the housing 11.

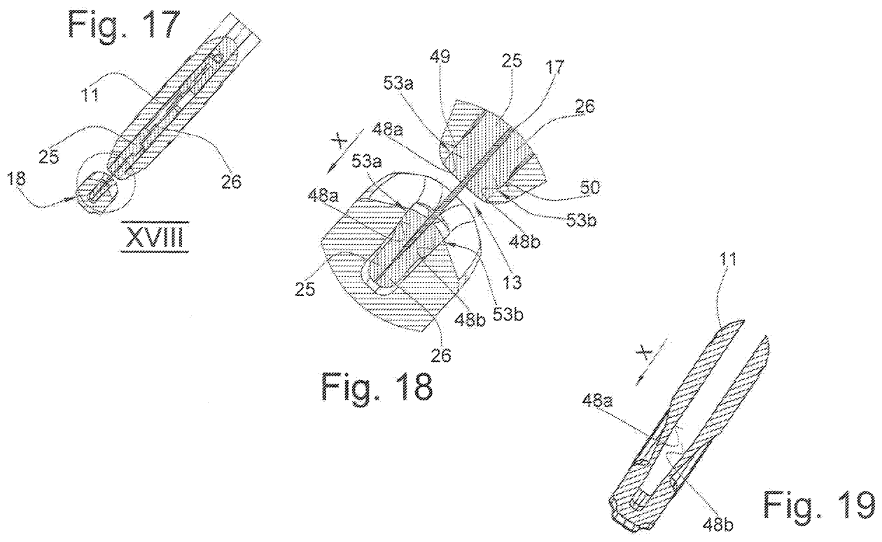

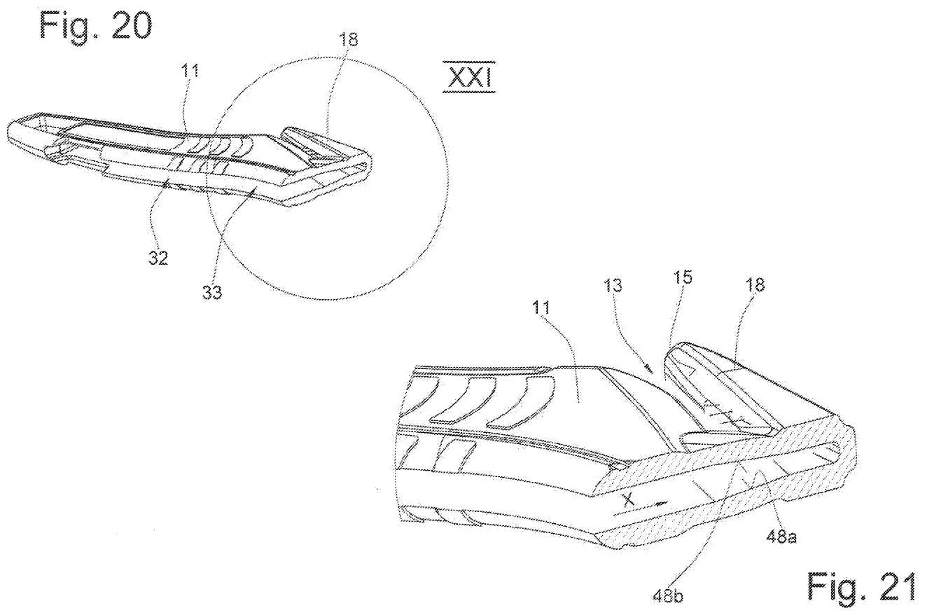

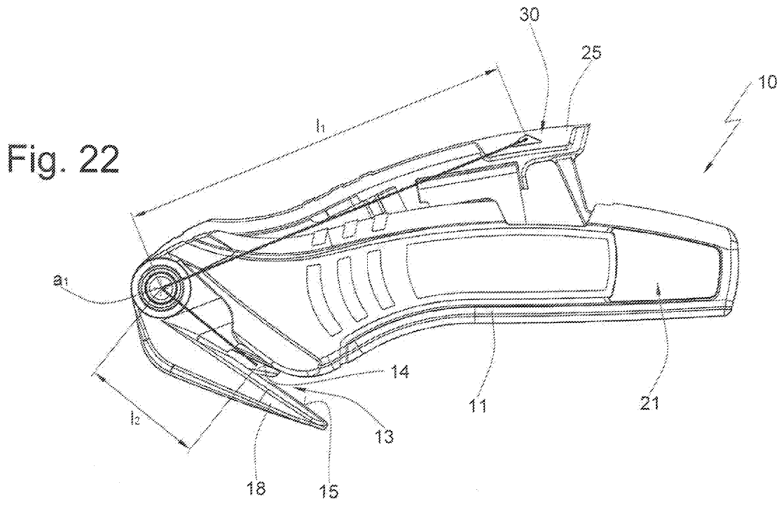

FIGS. 17 to 21 show that the housing 11 is provided with housing surfaces 48a and 48b running obliquely to the movement plane of the blade support 25, as a result of which a region of the interior 33 tapers conically in direction x in the pivoting direction u2 of the blade support 25. In this manner, the blade 17 is clamped increasingly between the blade support 25 and the blade cover 26 during the movement in direction u2 into the operating position, because the surface 48a exerts a force onto an outer surface 49 of the blade support 25 and the surface 48b exerts a force onto the outer surface 50 of the blade cover 26. FIGS. 17 and 18 also show that the projections 53a and 53b, which are next to the recess 13, together with the housing surfaces 48a and 48b increase the clamping force in the area next to the recess so that no material can enter between the blade 17 and the blade support 25 or the blade cover 26. In this manner, the blade 17 is held without play in the housing 11. So that the blade support 25 can nonetheless be pivoted without great effort into the operating position, the actuating region 30 is on the end region 28. According to FIG. 22, a large lever ratio of a first lever that has a length 11, to a second lever that has a length 12, therefore results. The first lever extends from the pivot axis a₁ to the actuating region 30 and the second lever extends from the pivot axis a₁ to the region of the housing 11 where the housing surfaces 48a and 48b are constructed.

I claim:

1. A knife comprising:
an elongated housing having a channel-shaped laterally open recess;
a blade;
a support having a support outer surface and pivotal about an axis on the housing between an operating position and a blade-replacement position;
a cover having a cover outer surface and movable on the support between a position holding the blade against the support and a position free of the blade, the support
in the operating position being inside the housing and holding the blade inside the housing with only a part of a cutting edge of the blade exposed in the recess for engagement with material to be cut and with the support outer surface interacting with a first housing surface and the cover outer surface interacting with a second housing surface such that the blade is clamped in a blade seat between the support and the cover, the support,
in the blade-replacement position, being so far out of the housing that the cover can free and expose all of the blade so the blade can be replaced, the cover and support forming respective oppositely outwardly directed cover and support outer surfaces and the housing being formed with confronting inwardly directed inner housing surfaces that in the operating position engage the outer surfaces and clamp the cover into the blade seat against the support; and
a projection formed on one of the outer or housing surfaces or projecting toward the other of the outer surface or housing surface, the blade being clamped by the projection between the cover and the housing in the operating position.

2. The knife according to claim 1, wherein the support pivots the blade about the axis between the blade-replacement position and the operating position within a plane.

3. The knife according to claim 2, wherein at least one of the housing surfaces is inclined toward the plane in a clamping region.

4. The knife according to claim 2, wherein at least one of the outer surfaces is inclined toward the plane in a clamping region.

5. The knife according to claim 4, wherein the two housing surfaces taper relative to each other in the clamping region or the two outer surfaces taper relative to each other in the clamping region.

6. The knife according to claim 1, wherein one of the outer surfaces or one of the housing surfaces is inclined in such a manner that clamping forces acting on the outer surfaces increase during pivotal movement of the support from the blade-replacement position into the operating position.

7. The knife according to claim 4, wherein at least in the clamping region the housing is elastically deformable so that the first housing surface and the second housing surface can be spread counter to an elastic restoring force of the housing.

8. The knife according to claim 1, wherein the support forms a pivot joint with the housing and pivots about the axis between the operating position and the blade-replacement position.

9. A knife comprising:
an elongated housing having a channel-shaped laterally open recess;
a blade;
a support having a support outer surface and pivotal about an axis on the housing between an operating position and a blade-replacement position outside the housing;
a cover having a cover outer surface and movable on the support between a position holding the blade against the support and a position free of the blade, the support
in the operating position being inside the housing and holding the blade with only a part of a cutting edge of the blade exposed in the recess for engagement with material to be cut with the support outer surface interacting with a first housing surface and the cover outer surface interacting with a second housing surface such that the blade is clamped between the support and the cover and
in the blade-replacement position, the support being moved so far out of the housing that the cover is movable to expose the blade so the blade can be replaced, the cover and support forming respective oppositely outwardly directed cover outer surface and support outer surface and the housing being formed with confronting inwardly directed inner housing surfaces that in the operating position of the support engage the outer surfaces and clamp the cover into the blade seat against the support; and
a projection partially surrounding the recess, formed on one of the outer or housing surfaces, and projecting toward the other of the outer surfaces or housing surfaces for clamping the blade between the cover and the housing in the operating position of the support.

10. A knife comprising:
an elongated housing having a laterally open recess;
a blade;
a support having a blade seat constructed to hold the blade, the support being pivotal about an axis on the housing between an operating position with the blade seat inside the housing and only a part of a cutting edge of the blade exposed in the recess for engagement with material to be cut and a blade-replacement position with the blade seat outside the housing; and
a cover on the support and movable on the support between a closed position clamping the blade against the blade seat of the support and an open position free of the blade and exposing the blade for removal from the blade seat, the cover and support forming respective oppositely outwardly directed cover and support outer surfaces and the housing being formed with confronting inwardly directed inner housing surfaces that in the operating position of the support engage the outer surfaces and clamp the cover into the blade seat against the support.

11. The knife according to claim 10, wherein the cover is pivotal on the support.

12. The knife according to claim 10, wherein the outer and inner surfaces are nonparallel and relatively angled such that on movement of the support from the blade-replacement position into the operating position the outer surfaces engage with increasing clamping force.

13. A knife comprising:
an elongated housing having a channel-shaped laterally open recess and forming first and second housing surfaces;
a blade;
a support having a support outer surface and pivotal about an axis on the housing between an operating position and a blade-replacement position; and
a cover having a cover outer surface and movable on the support between a position holding the blade against the support and a position free of the blade, the first and second housing surfaces tapering relative to each other in a clamping region or the outer surfaces tapering relative to each other in the clamping region,
the support
in the operating position being inside the housing and holding the blade inside the housing with only a part of a cutting edge of the blade exposed in the recess for engagement with material to be cut and with the support outer surface interacting with the first housing surface and the cover outer surface interacting with the second housing surface such that the blade is clamped in a blade seat between the support and the cover, and,
in the blade-replacement position, the support being so far out of the housing that the cover frees and exposes all of the blade so the blade can be replaced.
